(19) United States
(12) Patent Application Publication
(10) Pub. No.: US 2020/0129847 A1
(43) Pub. Date: Apr. 30, 2020

(54) BOARD GAME SIMULATING A BATTLE TO CAPTURE AN ENEMY BASE

(71) Applicant: Christian E. Andersen, Menlo Park, CA (US)

(72) Inventor: Christian E. Andersen, Menlo Park, CA (US)

(21) Appl. No.: 16/664,441

(22) Filed: Oct. 25, 2019

Related U.S. Application Data
(60) Provisional application No. 62/750,262, filed on Oct. 25, 2018.

(51) Int. Cl. A63F 3/00; G06F 16/22

(52) U.S. Cl. CPC A63F 3/00075; G06F 16/2264; G06F 7/588; A63F 3/00697; A63F 3/00895

(57) ABSTRACT

One embodiment is directed to a gaming system for allowing players to experience a simulated battle scenario, comprising: a plurality of gamepieces for each of the players comprising a base gamepiece for each player and being configured such that each gamepiece has operational characteristics selected to determine movement and impact upon other gamepieces, as dictated by a multifactorial lookup table; a gameboard; and a points accounting module; wherein when one of the players has a turn, such player is able to make operational decisions regarding the gamepieces controlled by such player based upon interoperability between the multifactorial lookup table, positions of the gamepieces on the gameboard, and an operating points budget provided by the points accounting module for the turn.

### RELATED APPLICATION DATA

This application claims the benefit of priority to U.S. Provisional Patent Application Ser. No. 62/750,262, filed on Oct. 25, 2018 and entitled “Board Game Simulating a Battle to Capture an Enemy Base” with docket reference CEA-101.

### FIELD OF THE INVENTION

The present invention relates generally to board games, and more specifically to a board game configured for a simulated battle, with pieces which may be configured to represent various types of troops, and configurations for providing for movement, as well as various offensive and defensive maneuvers.

### BACKGROUND

There is a desire and need for board games of sophistication and complexity, such as for a board game simulating fairly realistic battle scenarios without the typical downsides of existing games, such as large numbers of pieces, lengthy gameplay, and complicated rules. Historically, the confluence of such factors has yielded cumbersome play wherein the player must concentrate more on the tools available in the game rather than the strategy of the game itself.

For example, Risk™ is a strategy board game of diplomacy, conflict, and conquest for two to six players, that generally is played on a board depicting a political map of the earth, divided into forty-two territories, which are grouped into six continents. Turns rotate among players who control armies of playing pieces with which they attempt to capture territories from other players, with results determined by dice rolls. The goal of the game is to occupy every territory on the board and in doing so, eliminate the other players. Attacks may only be initiated by adjacent territories. The game can be lengthy, often requiring hours to days to complete.

Warhammer 40,000™ is a simulation of a terrestrial battle between two or more armies. Players use miniature models that represent futuristic warriors and fighting vehicles. The playing field is typically a tabletop diorama of a battlefield, comprising scale models of buildings, hills, trees, and other landmarks. Players take turns to move their models across the playing field and pretend that the models are shooting at each other. The outcomes of fights between models are determined by dice rolls, and distance measurements using rulers and/or tape measures must be made to define the maximum extent of troop movement and weapon range making play cumbersome. While providing for nonadjacent attacks, the game is often lengthy, requiring several hours to days to complete.

Unlike existing battle simulation games, the present invention utilizes resource traits such as movement, weapons range, weapon abilities, and resistance to damage, while maintaining a straightforward and unobtrusive method of play providing for games between 2 or more players that, in various embodiments, may be configured to last for between 5 to 45 minutes on average.

### SUMMARY

One embodiment is directed to a gaming system for allowing two or more players to experience a simulated battle scenario, comprising: a plurality of gamepieces for each of the players, the plurality comprising a base gamepiece for each player and being configured such that each gamepiece has operational characteristics selected to determine movement and impact upon other gamepieces, as dictated by a multifactorial lookup table; a two-dimensional gameboard featuring two orthogonal movement axes, the gameboard divided into a plurality of unique spaces defined by the orthogonal movement axes, each of which may be occupied by one of the plurality of gamepieces; and a points accounting module configurable to provide an operating points budget which may be utilized in each of a sequence of turns by each of the players, the operating points budget defining a maximum aggregate points quantification which may be utilized to implement operational characteristics for at least a single gamepiece for such turn as dictated by the multifactorial lookup table; wherein when one of the players has a turn, such player is able to make operational decisions regarding the gamepieces controlled by such player based upon interoperability between the multifactorial lookup table, positions of the gamepieces on the gameboard, and the operating points budget provided by the points accounting module for the turn. The gamepieces may be selected from the group consisting of: a base piece, a squad piece, a tank piece, a sniper piece, a chief piece, a drone piece, and a paratrooper piece. The gamepiece operational characteristics may be selected from the group consisting of: an allowed maximum movement of a gamepiece per command; a number of life points; a number of attack points; an attack range; an attack cost; a recruitment cost; and a special ability. The multifactorial lookup table may comprise a matrix of predetermined values for the operational characteristics of the gamepieces. The gameboard may comprise a generally planar playing surface. Certain of the spaces of the gameboard may be permanently designated for a specific operational purpose. The specific operational purpose may be selected from the group consisting of: recruitment and base location. The points accounting module may comprise a points tallying table which may be filled out by a player to account for such player's budget and utilization of points. The points accounting module may comprise a card configured to be manually filled out by the player. The points accounting module may comprise a computer-software-based table created to be operated by the player utilizing a personal computing system. The personal computing system may be selected from the group consisting of: a smartphone, a personal computer, a tablet computer, and an electronic gaming console. The operating points budget may be varied between sequential turns. The operating points budget may be varied by user activation of a chance-based points selector configured to return a points value from a predetermined superset of values. The chance-based points selector may be selected from the group consisting of: a spinner; a die; and an electronic random number generator. One player's gamepiece may be defeated if the life points associated with such gamepiece are less than or equal to the cumulative attack points utilized against it by another player. A player may be deemed to have lost a game when a base gamepiece of such player has been defeated. The gameboard may be configured to define rows and columns of spaces, wherein one or more of the spaces of a second row of the gameboard are permanently designated for the specific operational purpose of comprising a base location, and wherein one or more other spaces of first row of the gameboard are permanently designated for the specific operational purpose of comprising a recruitment location.

Another embodiment is directed to a gaming method for allowing two or more players to experience a simulated battle scenario, comprising: providing a plurality of gamepieces for each of the players, the plurality comprising a base gamepiece for each player and being configured such that each gamepiece has operational characteristics selected to determine movement and impact upon other gamepieces, as dictated by a multifactorial lookup table; providing a two-dimensional gameboard featuring two orthogonal movement axes, the gameboard divided into a plurality of unique spaces defined by the orthogonal movement axes, each of which may be occupied by one of the plurality of gamepieces; providing a points accounting module configurable to provide an operating points budget which may be utilized in each of a sequence of turns by each of the players, the operating points budget defining a maximum aggregate points quantification which may be utilized to implement operational characteristics for at least a single gamepiece for such turn as dictated by the multifactorial lookup table; and facilitating a sequence of turns between the players, such that when one of the players has a turn, such player is able to make operational decisions regarding the gamepieces controlled by such player based upon interoperability between the multifactorial lookup table, positions of the gamepieces on the gameboard, and the operating points budget provided by the points accounting module for the turn. The gamepieces may be selected from the group consisting of: a base piece, a squad piece, a tank piece, a sniper piece, a chief piece, a drone piece, and a paratrooper piece. The gamepiece operational characteristics may be selected from the group consisting of: an allowed maximum movement of a gamepiece per command; a number of life points; a number of attack points; an attack range; an attack cost; a recruitment cost; and a special ability. The multifactorial lookup table may comprise a matrix of predetermined values for the operational characteristics of the gamepieces. The gameboard may comprise a generally planar playing surface. Certain of the spaces of the gameboard may be permanently designated for a specific operational purpose. The specific operational purpose may be selected from the group consisting of: recruitment and base location. The points accounting module may comprise a points tallying table which may be filled out by a player to account for such player's budget and utilization of points. The points accounting module may comprise a card configured to be manually filled out by the player. The points accounting module may comprise a computer-software-based table created to be operated by the player utilizing a personal computing system. The personal computing system may be selected from the group consisting of: a smartphone, a personal computer, a tablet computer, and an electronic gaming console. The operating points budget may be varied between sequential turns. The operating points budget may be varied by user activation of a chance-based points selector configured to return a points value from a predetermined superset of values. The chance-based points selector may be selected from the group consisting of: a spinner; a die; and an electronic random number generator. One player's gamepiece may be defeated if the life points associated with such gamepiece are less than or equal to the cumulative attack points utilized against it by another player. A player may be deemed to have lost a game when a base gamepiece of such player has been defeated. The gameboard may be configured to define rows and columns of spaces, wherein one or more of the spaces of a second row of the gameboard are permanently designated for the specific operational purpose of comprising a base location, and wherein one or more other spaces of first row of the gameboard are permanently designated for the specific operational purpose of comprising a recruitment location.

### BRIEF DESCRIPTION OF THE DRAWINGS

FIG. 1 illustrates a flow chart representing one embodiment of gameplay in an instantiation of the present invention.

FIG. 2 illustrates a game board suitable for practicing one embodiment of the present invention.

FIG. 3 illustrates a multifactorial lookup table featuring various attributes of game playing elements for various embodiments of the subject invention.

FIGS. 4A-4G illustrates a variety of different gamepieces suitable for practicing the present invention.

FIGS. 5A through 5E illustrate various aspects of an exemplary scenario to further illustrate gameplay in accordance with the present invention.

### DETAILED DESCRIPTION

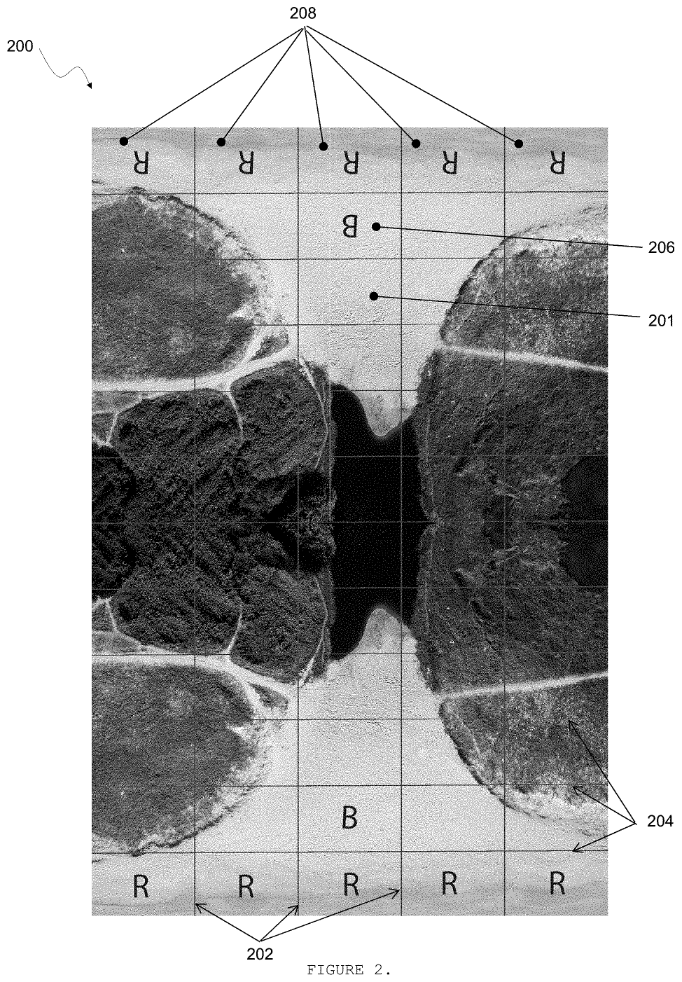

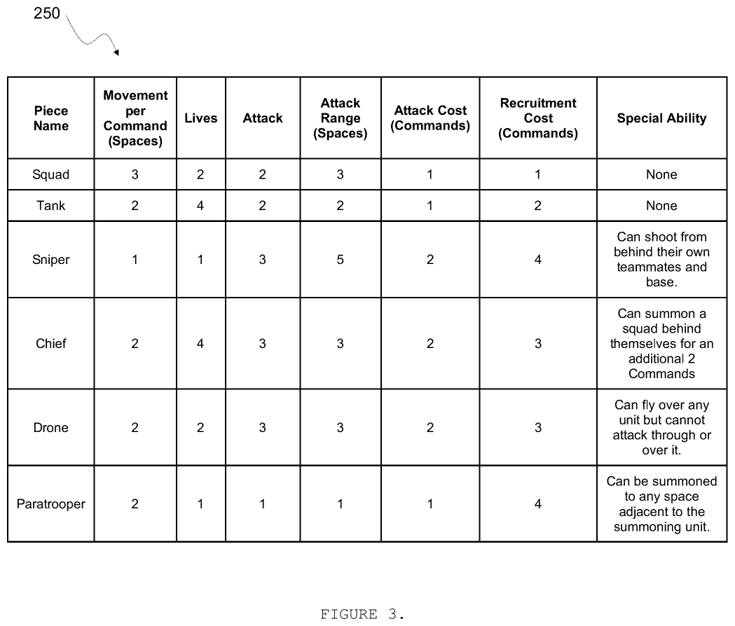

The game of the present invention is unique because the playing surface is made up of a fixed grid upon which all pieces except the base piece may move and interact with each other as a function of an allowed interaction distance and overall effect mostly, but not always, while the gamepieces are in direct view of each another, and utilizing a fixed base location, which may be in the second row of spaces, such as is shown in the non-limiting example of FIG. 2, that provides a nearby location for most, but not all, other pieces to be summoned into play. Abilities may be attributed to pieces, such as a maximum movement distance per command used, maximum range to target, and overall defensive points that represent their efficacy. Certain pieces may also have further special abilities that allow for them to target and assail an opponent's pieces from behind other pieces, affording them protection from pieces without such abilities. Pieces may be summoned (or “Recruited” from a “Barracks” or “Recruitment Depot” in military parlance) to play in a row of spaces behind the aforementioned base, in the second row of spaces, for example. Furthermore, rather than being beginning play nearby to a base piece, certain pieces may be called to immediate adjacency to certain other pieces already in play, as deemed possible through a special ability of that gamepiece. Command points may be issued to call pieces onto the gameboard (or “playfield”). Players may collect command points at a fixed rate throughout the game, or alternately, command points may be accumulated at a rate dependent upon the specific pieces in play and/or the overall quantity of at least a single player's pieces in play, or alternately, command points may be accumulated based upon a roll of a die, or by a combination of these methods. By way of non-limiting example, Commands may be accumulated such that a player always begins their turn with a constant value of Commands, such as 6 points. Gamepieces may be ascribed characteristics of an armed force, such as, for example; a platoon or squad, a tank, a sniper, a sergeant or chief, a drone, and a paratrooper. By way of non-limiting example, these attributes may be as listed in table 250 of FIG. 3. The values associated with a gamepiece may be referred to as the “operational characteristics” of said gamepiece. Values for said operational characteristics may be numerical, such as may represent the number of spaces over (or across) which a resource may attack another player's resource, or descriptive, such as “can shoot from behind their own teammates and/or base” when the game system is otherwise configured to disallow anything that an unobstructed attack between gamepieces.

The gamepieces comprising a player's Barracks at the start of a game may contain a plurality of similar or identical gamepieces, such as the following non-limiting example; one Base, one Chief, one Sniper, two Drones, two Tanks, three Paratroopers, and three Squads. Of course, other configurations may be used to alter gameplay and are considered to be within the scope of the present invention.

In one embodiment, a game may be configured such that the base gamepieces are placed on their respective base spaces, a fixed number of initial (preexisting) command points are allotted to each player, e.g. 5, and a die rolled to determine who summons (“recruits”) resources first. The player going first may choose to summon a number of resources that deplete their command points or summon fewer and use the remaining command points to move the summoned troops or save said remaining accumulated points for a subsequent turn. A points accounting module may be employed to account for the various points related to various attributes of the game, including but not necessarily limited to the command points of a player and the life points of a gamepiece. Once the first player's turn is completed, the second player may do likewise. As each player accumulates command points during play, the type and quantity of summoned resources may vary with each turn. The object of the game is to capture (i.e. defeat) your opponent's base. Play may be declared to be over once a base is defeated and the conquering player wins. A gamepiece (or “troop” or “resource”, or “unit”) may further comprise Special Abilities. For example, a special ability may allow a troop to be recruited to a space adjacent to another gamepiece, as is shown in the example of the paratrooper in table 250 of FIG. 3. Optionally, a special ability may allow a resource to recruit another resource to an adjacent space (such as, behind themselves), as is shown in the example of the chief in table 250 of FIG. 3. Optionally, a special ability may allow a resource to move through a space occupied by another resource, as is shown in the example of the drone in table 250 of FIG. 3. Optionally, a special ability may allow a resource to attack through a space occupied by another resource, as is shown in the example of the sniper in table 250 of FIG. 3. A resource may have more than a single special ability, but that may lead to said gamepiece being “overpowered” with respect to other gamepieces in play.

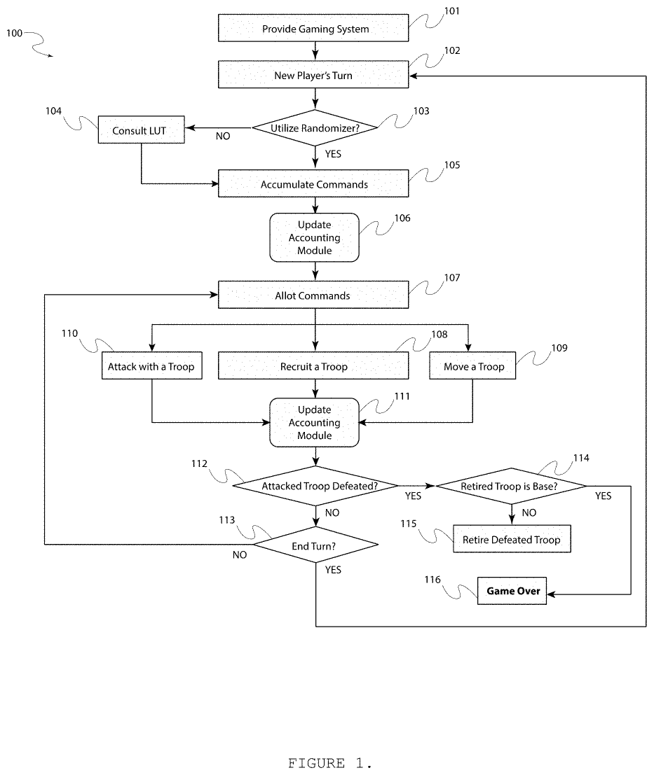

Referring to FIG. 1, containing flowchart 100 that describes the steps involved with practicing an embodiment of the present invention, consisting of steps 101 through 116. In Step 101 a gaming system may be provided and a gameboard assembled and gamepieces distributed to each player and each player's Base gamepiece may be placed at a specified location for said base gamepieces on the gameboard, such as base space 206 on FIG. 2. Following Step 101 may be Step 102, wherein a turn is directed to a single player, who may then proceed to play per the remaining steps. If this is the first turn of the game, a player may be chosen to go first, either by the roll of a die, or other such means, such as a spinner or an electronic random number generator. This may be referred to herein as a “randomizer”. In one embodiment, Commands may be budgeted at a fixed rate, such as, by way of non-limiting example, 5 per turn. Alternately, Commands may be budgeted by a randomizer. In a further alternate embodiment, commands may be budgeted based at least in part on the number of gamepieces a player has recruited and are presently in play. Optionally, to provide for a variety in play, certain special abilities may be ascribed to a gamepiece, such as, by way of non-limiting examples, the ability to shoot from behind gamepieces controlled by the same player, the ability to summon a squad to an adjacent space for an additional cost of command points, the ability to travel over spaces occupied spaces, and the ability to be recruited to a space adjacent to a recruiting gamepiece. Optionally, command points may be reset at the start of each turn to a predetermined value. Optionally, command points may be reset at the start of each turn to a randomized value by a randomizer. Step 103 may be utilized to provide a randomized amount of command points to be budgeted to a player. Alternately, step 104 may be used to provide a predetermined amount of command points to be budgeted to a player. Following either step 103 or step 104 may be Step 105, wherein a player may accumulate the aforementioned command points (or equivalently, “Commands”) prior to taking any actions during said player's turn. Following step 105, may be step 106, wherein an accounting module may be updated with to account for the accumulated command points of step 105, and may be an increase in available commands. The accounting module (or “points accounting module”) may be an update or augmentation to table 250 of FIG. 3, and/or a tally sheet, and/or a computer-software-based table created to be operated by the player utilizing a personal computing system, by way of non-limiting examples. At this point, operational decisions regarding the gamepieces may be made, such as in Step 107, wherein said player may allocate their commands by recruiting more troops to the gameboard or allocating them otherwise amongst the pieces already in play for movement and/or attack, represented by Steps 108, 109, and 110, respectively. Specifically, Step 108 represents Recruitment (which may also be referred to as “Summoning”), wherein troops may be recruited from said player's stockpile of gamepieces reside in their Barracks (or “Recruitment Depot”) and may be placed on the gameboard on a space dedicated for recruitment, such as is illustrated by recruitment spaces 208 of FIG. 2, or in a manner appropriate for an ascribed special ability, such as is given in column 8 of Table 250 in FIG. 3, and the cost of Recruitment, such as is given in column 7 of Table 250 in FIG. 3. Subsequent to step 108, step 111 may be utilized. Similar to that of step 106, step 111 comprises an updating of the points in the accounting module to account for the points expended in recruiting troops to the battlefield. Unlike step 106, step 111 may account for a decrease in available commands. Following step 111 immediately after step 108, step 112 may be moot, as no troop was attacked and the player may proceed to either step 113 and end their turn, thus allowing a next player to begin at step 102 or proceed to step 107 if they a) desire to maintain their turn and b) have remaining commands and reallocate at least some of said remaining commands. Following step 107, a player may proceed to step 109 and move a gamepiece (or “tile” or “troop) may be moved from its present location on the gameboard to another location at a cost of 1 Command per Movement and move at most set maximum number of unoccupied spaces, such as the example given in column 2 of Table 250 in FIG. 3 or in a manner appropriate for an ascribed special ability, such as is given in column 8 of Table 250 in FIG. 3. Subsequent to step 109, step 111 may be utilized. Following the troop movement, step 111 may be utilized to update of the points in the accounting module to account for the points expended in moving troops on the battlefield and may account for a decrease in available commands. Following step 111 immediately after step 109, step 112 may be moot, as no troop was attacked and the player may proceed to either step 107 if they have remaining commands and reallocate at least some of said remaining commands, or to either step 113 and end their turn, thus allowing a next player to begin at step 102 or proceed to step 107 if they a) desire to maintain their turn and b) have remaining commands and reallocate at least some of said remaining commands. Following step 107, a player may proceed to step 110, wherein one of said player's gamepieces may be made to Attack an opponent's gamepiece. An attack may be made on an opponent's gamepiece when the number of spaces between the instant gamepieces are either all in a row or all in a column and the number of said intervening spaces is less than or equal to the attacking troop's “Attack Range”, such as is described in column 5 of Table 250 in FIG. 3, or in a manner appropriate for an ascribed special ability, such as is given in column 8 of Table 250 in FIG. 3. Following step 111 immediately after step 110, step 112 may be considered, as an opposing troop was attacked and the player may proceed to either step 113 and end their turn, thus allowing a next player to begin at step 102 or proceed to step 107 if they a) desire to maintain their turn and b) have remaining commands and reallocate at least some of said remaining commands. The amount of damage incurred by the opponent's troop may be equal to the attacking troop's Attack Points (or “attack strength”), such as is given in column 3 of Table 250 in FIG. 3, and Attack points may be subtracted from the attacked troop's Lives points and the points accounting module may be utilized for this purpose. Furthermore, following the attack, step 111 may be utilized to update of the attacking player's points in the accounting module to account for the points expended in attacking and may account for a decrease in available commands. Following step 111 may be step 112, wherein an opponent's gamepiece may be deemed to be defeated because it has suffered cumulative damage greater than or equal to the life points of said opponent's gamepiece. The now defeated gamepiece may be retired and returned to that player's recruitment depot and made available for later use, unless it is a Base that is defeated. Said retired gamepiece may be unavailable for use until said player's next turn, or beyond, depending upon predetermined initial conditions of the game, which may be included as an element of the multifactorial lookup table. Alternately, said retired gamepiece may be unavailable for use until a fixed number of said player's turns, as determined by a randomizer. Following step 112 may be step 114, wherein the game may progress to step 115 and the troop retired, or to step 116 if a Base is defeated and ends the game with player controlling the defeated base losing. Otherwise, a player's turn may continue until they exhaust their Command points, or said player affirmatively ends their turn, as represented by the YES decision branch of Step 113. For example, an operating player may choose to recruit a gamepiece, move said gamepiece, attack an opponent's gamepiece with said gamepiece, then recruit a different gamepiece and iterate if the points are available to do so, for which the points accounting module may be utilized. Optionally, the damage suffered by a Base may be increased when it is attacked from behind, such as may be possible from recruitment spaces 208 in the example of FIG. 2. The set of points associated with any or all of the following may be referred to as or “Operating Points” or “Operational Points”; Commands, Attacks, Attack Costs, Attack Ranges, Movements, Movements Costs, Lives, and Recruitment Costs, such as is given in the example of table 250 of FIG. 3, and may be accounted for using a points accounting module. The points accounting module may be an update or augmentation to table 250 of FIG. 3, and/or a tally sheet, and/or a computer-software-based table created to be operated by the player utilizing a personal computing system, by way of non-limiting examples. Furthermore, a personal computing may be a smartphone, a personal computer, a tablet computer, and/or an electronic gaming console, by way of non-limiting examples.

In certain embodiments, the value of the number of command points given at the start of the game and/or at the start of a turn may be between 1 point and 10 points. Optionally, said number of points may be between 3 points and 5 points. Optionally, said number of points may be set at 5 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, the value of the number of attack points for a given troop type may be between 1 point and 10 points. Optionally, said number of points may be between 3 points and 5 points. Optionally, said number of points may be set at 5 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, the value of the attack range for a given troop type may be between 1 space and 5 spaces. Optionally, said number of points may be between 2 spaces and 4 spaces. Optionally, said number of points may be the result of a n-sided die roll and be between 1 space and n spaces, per the outcome of the die roll. Optionally, an n=6-sided die may be used. Optionally, a randomizer may be used to determine said number of spaces. Optionally, a die roll or a randomized determination may be on per-turn or per-game basis.

In certain embodiments, the value of the movement per command point for a given troop type may be between 1 space and 5 spaces. Optionally, said number of points may be between 2 spaces and 4 spaces. Optionally, said number of points may be the result of a n-sided die roll and be between 1 space and n spaces, per the outcome of the die roll. Optionally, an n=6-sided die may be used. Optionally, a randomizer may be used to determine said number of spaces. Optionally, a die roll or a randomized determination may be on per-turn or per-game basis.

In certain embodiments, the value of life points for a given troop type may be between 1 point and 5 points. Optionally, said number of points may be between 2 points and 4 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, the value of attack cost for a given troop type may be between 1 point and 5 points. Optionally, said number of points may be between 2 points and 4 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, the value of life points for a given troop type may be between 1 point and 5 points. Optionally, said number of points may be between 2 points and 4 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, the recruitment cost for a given troop type may be between 1 point and 5 points. Optionally, said number of points may be between 2 points and 4 points. Optionally, said number of points may be the result of a n-sided die roll and be between 1 point and n points, per the outcome of the die roll. Optionally, an n=6-sided die may be used. Optionally, a randomizer may be used to determine said number of points. Optionally, a die roll or a randomized determination may be on per-turn or per-game basis.

In certain embodiments, a value of a special ability may be selected from the group consisting of; no ability, the ability to shoot from behind gamepieces controlled by the same player, the ability to summon a squad to an adjacent space for an additional cost of command points, the ability to travel over spaces occupied spaces, the ability to be recruited to a space adjacent to a recruiting gamepiece, and combinations thereof. Optionally, a threshold value maybe utilized in a randomized way to assign special abilities to troops, said threshold value may be the result of a n-sided die roll and be between 1 point and n points, per the outcome of the die roll. Optionally, an n=6-sided die may be used. Optionally, a randomizer may be used to determine if a particular gamepiece comprises a special ability. Optionally, a die roll or a randomized determination may be on per-turn or per-game basis to assign special abilities once a threshold value is determined.

FIG. 2 is directed at an embodiment comprising a gameboard (or “playfield”), gameboard 200, containing an optional geographic background image. Other images may be used, such as a battlefield image and a map image, by way of non-limiting examples. Gameboard 200 is comprised of plurality of Spaces 201 (or “squares”), being delineated by Column Borders 202 and Row Borders 204. It is further configured in this exemplary embodiment to included specific Spaces for each player's Base, shown as Base Spaces 206, behind which are a plurality of Recruitment Spaces 208. Recruitment Spaces 208 may be designated as the spaces available as starting locations for recruited Troops, unless the Troops have special abilities that allow them to be recruited elsewhere, such as is given in column 8 of Table 250 in FIG. 3, by way of non-limiting example. In the present example, Gameboard 200 is a 5×12 matrix, may be configured differently and all such configurations are considered to be within the scope of the present invention. Recruitment spaces 208 may be placed in locations different than that shown in this exemplary embodiment. Furthermore, said recruitment spaces 208 may be placed adjacent to one another, or separated from one another, or a combination thereof.

FIG. 3 is directed at a multifactorial lookup table, table 250, comprising attributes of the gamepieces; such as a name, a movement per command (or “an allowed maximum movement of a gamepiece per command”), a number of attack points, an attack range (as may be measured in spaces), an attack cost, a number of life points (or “lives”), a recruitment cost, and a special ability. Command points may be used to compensate for movement, attack cost, and recruitment. Life points and attack points may be considered, along with command points, as “operational points” and be made part of an operational points budget and interoperated with a points accounting module to account for increments and decrements for a gamepiece or gamepieces during play. For example, a squad may be initially configured with 2 life points, which may be decremented from 2 to 1 after an attack by a paratrooper, as is defined per the example of Table 250 in FIG. 3. Although not shown, a gamepiece's ability to be recruited following retirement may also be listed in said multifactorial lookup table, as was described earlier with respect to FIG. 2.

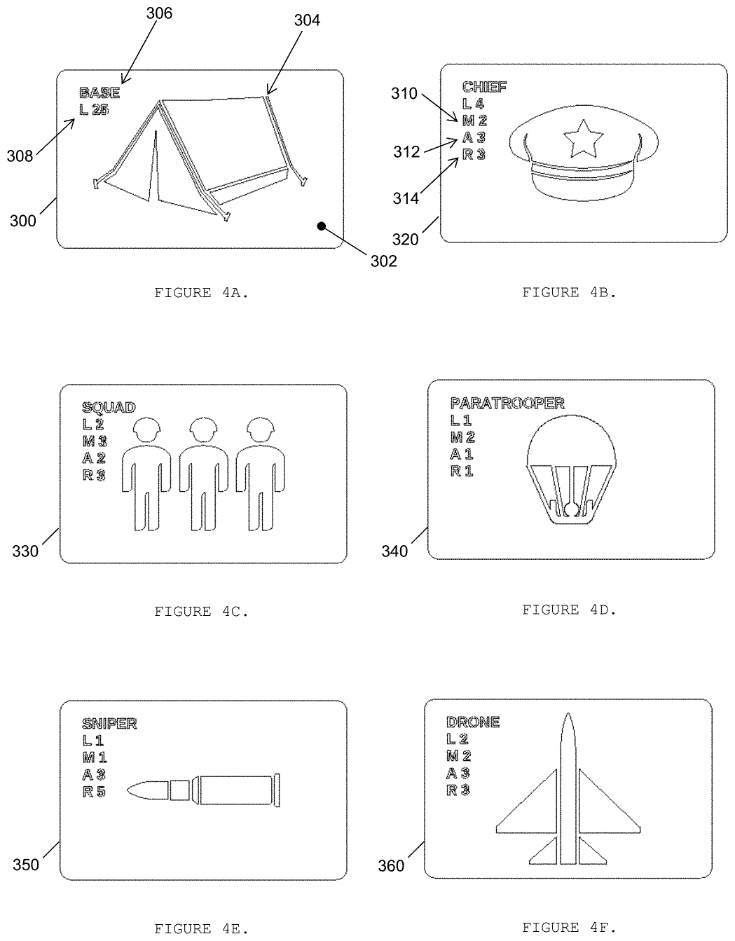

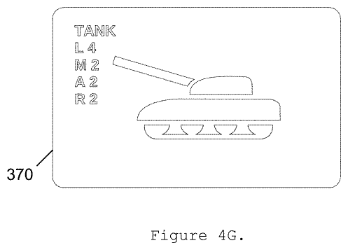

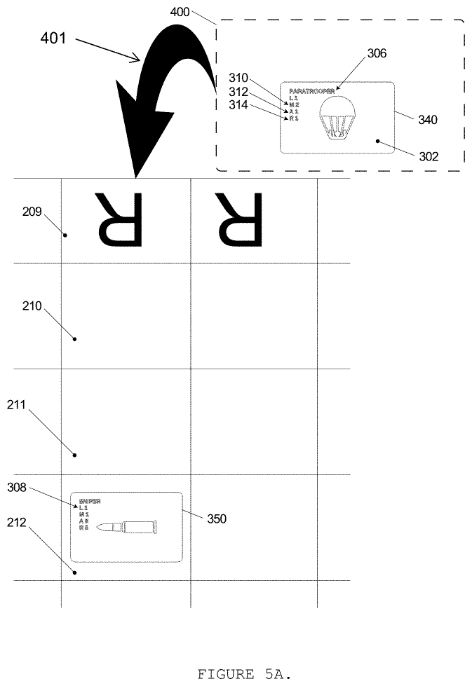

FIGS. 4A through 4G are directed at different types of exemplary gamepieces for practicing the present invention, although other configurations are possible and are considered to be within the scope of the present invention.

FIG. 4A is directed at a Gamepiece 300 that is configured as a Base, consisting of a Tile 302, a printed Name 306, a printed Graphic 304, and a printed number of Life Points 308 (or “lives” or “hit points” or “health points” or “defensive points”) as may be defined per the example of Table 250 in FIG. 3. A Tile 302 may be made to be about the same size of Spaces 201 on Gameboard 200.

FIG. 4B is similar to that of FIG. 4A, designated as Game Piece (or “gamepiece”) 320, with the differences of Tile 302 being configured as a Chief, as shown in Name 306, and further configured with a printed Movement Limit 310, a printed Attack Points 312 (or “damage points”), and a printed Range 314, as may be defined per the example of Table 250 in FIG. 3.

FIG. 4C is similar to that of FIG. 4B, designated as Gamepiece 330, with the differences of Tile 302 being configured as a Squad with Lives 308, Range 314, Movement Limit 310, and Attack Points 312 as may be defined per the example of Table 250 in FIG. 3.

FIG. 4D is similar to that of FIG. 4C, designated as Gamepiece 340, with the differences of Tile 302 being configured as a Paratrooper, as shown in Name 306, with Lives 308, Range 314, Movement Limit 310, and Attack Points 312, as may be defined per the example of Table 250 in FIG. 3.

FIG. 4E is similar to that of FIG. 4D, designated as Gamepiece 350, with the differences of Tile 302 being configured as a Sniper, as shown in Name 306, with Lives 308, Range 314, Movement Limit 310, and Attack Points 312 as may be defined per the example of Table 250 in FIG. 3.

FIG. 4F is similar to that of FIG. 4E, designated as Gamepiece 360, with the differences of Tile 302 being configured as a Drone, as shown in Name 306, with Lives 308, Range 314, Movement Limit 310, and Attack Points 312 as may be defined per the example of Table 250 in FIG. 3.

FIG. 4G is similar to that of FIG. 4F, designated as Gamepiece 370, with the differences of Tile 302 being configured as a Tank, as shown in Name 306, with Lives 308, Range 314, Movement Limit 310, and Attack Points 312 as may be defined per the example of Table 250 in FIG. 3.

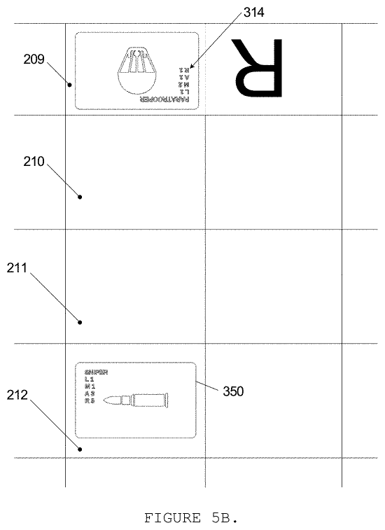

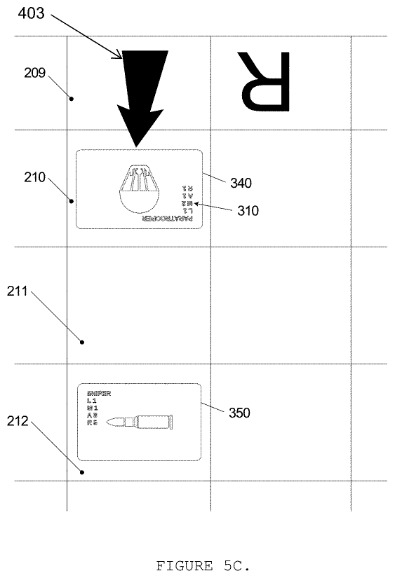

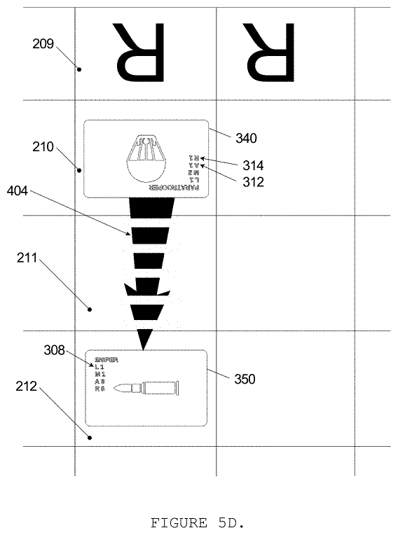

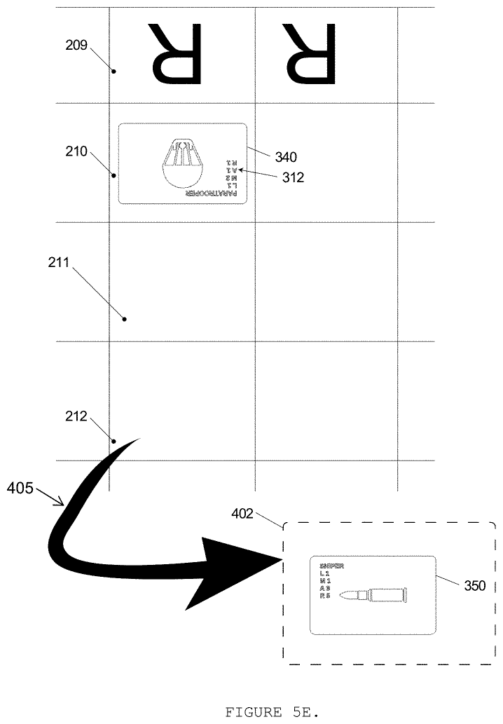

FIGS. 5A through 5E are directed at an exemplary scenario to further illustrate gameplay.

FIG. 5A depicts a portion of Gameboard 200, including Recruiting Space 209, Spaces 210, 211, and Space 212, whereupon is located a Gamepiece 350, configured with a value of 1 for Lives 308, as was described with respect to the example of FIG. 4E. A player Recruitment Depot 400 is depicted by a dashed line surrounding a Gamepiece 340 and may include all of said player's undisposed troops. Gamepiece 340 being configured with values of 2, 1, and 1 for Movement Limit 310, Attack 312, and Range 314, respectively, as were described with respect to the example of FIG. 4D. Arrow 401 depicts Recruitment from Recruitment Depot 400 to Gameboard 200 and corresponds to Step 105 of FIG. 1.

FIG. 5B shows Tile 340 in its initial position on Recruitment Space 209, being 2 spaces distant from Gamepiece 350, and costing the player 1 Command Point, such as is shown in Step 104 of FIG. 1. The points accounting module may be updated to reflect this expenditure of points.

Arrow 403 of FIG. 5C depicts the movement of Gamepiece 340 from Space 209 to Space 210, placing it at a distance of 1 space from Gamepiece 350, at a cost of 1 Command Point. The points accounting module may be updated to reflect this expenditure of command points for said operation. While Gamepiece 340 is shown as having a value of 2 for Movement Limit 310, its value of 1 for Range 314 places it within striking range of Gamepiece 350 after moving a single space, such as is shown in Step 107 of FIG. 1.

Arrow 404 of FIG. 5D depicts the attack of Gamepiece 350 by Gamepiece 340, per the printed value of 1 for Attack 312 and 1 for Range 314. The points accounting module may be updated to reflect this expenditure of command points for said operation. Opponent's Gamepiece 350 is configured with a value of 1 for Lives 308 and is thus defeated by the damage from the attack of Gamepiece 340, such as is shown in Step 109 of FIG. 1. The points accounting module may be updated to reflect this decrement of points for said gamepiece.

Arrow 405 of FIG. 5E depicts the retirement of Gamepiece 350 to Opponent's Recruitment Depot 402, such as is shown in Step 111 of FIG. 1. The points accounting module may be updated to reflect said gamepiece's retirement and reset to an initial value of points for said gamepiece.

Various exemplary embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Exemplary aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

1. A gaming system for allowing two or more players to experience a simulated battle scenario, comprising:
a. a plurality of gamepieces for each of the players, the plurality comprising a base gamepiece for each player and being configured such that each gamepiece has operational characteristics selected to determine movement and impact upon other gamepieces, as dictated by a multifactorial lookup table;
b. a two-dimensional gameboard featuring two orthogonal movement axes, the gameboard divided into a plurality of unique spaces defined by the orthogonal movement axes, each of which may be occupied by one of the plurality of gamepieces; and
c. a points accounting module configurable to provide an operating points budget which may be utilized in each of a sequence of turns by each of the players, the operating points budget defining a maximum aggregate points quantification which may be utilized to implement operational characteristics for at least a single gamepiece for such turn as dictated by the multifactorial lookup table;
wherein when one of the players has a turn, such player is able to make operational decisions regarding the gamepieces controlled by such player based upon interoperability between the multifactorial lookup table, positions of the gamepieces on the gameboard, and the operating points budget provided by the points accounting module for the turn.

2. The system of claim 1, wherein the gamepieces are selected from the group consisting of: a base piece, a squad piece, a tank piece, a sniper piece, a chief piece, a drone piece, and a paratrooper piece.

3. The system of claim 1, wherein the gamepiece operational characteristics are selected from the group consisting of: an allowed maximum movement of a gamepiece per command; a number of life points; a number of attack points; an attack range; an attack cost; a recruitment cost; and a special ability.

4. The system of claim 1, wherein the multifactorial lookup table comprises a matrix of predetermined values for the operational characteristics of the gamepieces.

5. The system of claim 1, wherein the gameboard comprises a generally planar playing surface.

6. The system of claim 5, wherein certain of the spaces of the gameboard are permanently designated for a specific operational purpose.

7. The system of claim 6, wherein the specific operational purpose is selected from the group consisting of: recruitment and base location.

8. The system of claim 1, wherein the points accounting module comprises a points tallying table which may be filled out by a player to account for such player's budget and utilization of points.

9. The system of claim 8, wherein the points accounting module comprises a card configured to be manually filled out by the player.

10. The system of claim 8, wherein the points accounting module comprises a computer-software-based table created to be operated by the player utilizing a personal computing system.

11. The system of claim 10, wherein the personal computing system is selected from the group consisting of: a smartphone, a personal computer, a tablet computer, and an electronic gaming console.

12. The system of claim 1, wherein the operating points budget may be varied between sequential turns.

13. The system of claim 12, wherein the operating points budget may be varied by user activation of a chance-based points selector configured to return a points value from a predetermined superset of values.

14. The system of claim 13, wherein the chance-based points selector is selected from the group consisting of: a spinner; a die; and an electronic random number generator.

15. The system of claim 3, wherein one player's gamepiece may be defeated if the life points associated with such gamepiece are less than or equal to the cumulative attack points utilized against it by another player.

16. The system of claim 15, wherein a player may be deemed to have lost a game when a base gamepiece of such player has been defeated.

17. The system of claim 7, wherein the gameboard is configured to define rows and columns of spaces, wherein one or more of the spaces of a second row of the gameboard are permanently designated for the specific operational purpose of comprising a base location, and wherein one or more other spaces of first row of the gameboard are permanently designated for the specific operational purpose of comprising a recruitment location.

18. A gaming method for allowing two or more players to experience a simulated battle scenario, comprising:
a. providing a plurality of gamepieces for each of the players, the plurality comprising a base gamepiece for each player and being configured such that each gamepiece has operational characteristics selected to determine movement and impact upon other gamepieces, as dictated by a multifactorial lookup table;
b. providing a two-dimensional gameboard featuring two orthogonal movement axes, the gameboard divided into a plurality of unique spaces defined by the orthogonal movement axes, each of which may be occupied by one of the plurality of gamepieces;
c. providing a points accounting module configurable to provide an operating points budget which may be utilized in each of a sequence of turns by each of the players, the operating points budget defining a maximum aggregate points quantification which may be utilized to implement operational characteristics for at least a single gamepiece for such turn as dictated by the multifactorial lookup table; and
d. facilitating a sequence of turns between the players, such that when one of the players has a turn, such player is able to make operational decisions regarding the gamepieces controlled by such player based upon interoperability between the multifactorial lookup table, positions of the gamepieces on the gameboard, and the operating points budget provided by the points accounting module for the turn.

19. The method of claim 18, wherein the gamepieces are selected from the group consisting of: a base piece, a squad piece, a tank piece, a sniper piece, a chief piece, a drone piece, and a paratrooper piece.

20. The method of claim 18, wherein the gamepiece operational characteristics are selected from the group consisting of: an allowed maximum movement of a gamepiece per command; a number of life points; a number of attack points; an attack range; an attack cost; a recruitment cost; and a special ability.

21. The method of claim 18, wherein the multifactorial lookup table comprises a matrix of predetermined values for the operational characteristics of the gamepieces.

22. The method of claim 18, wherein the gameboard comprises a generally planar playing surface.

23. The method of claim 22, wherein certain of the spaces of the gameboard are permanently designated for a specific operational purpose.

24. The method of claim 23, wherein the specific operational purpose is selected from the group consisting of: recruitment and base location.

25. The method of claim 18, wherein the points accounting module comprises a points tallying table which may be filled out by a player to account for such player's budget and utilization of points.

26. The method of claim 25, wherein the points accounting module comprises a card configured to be manually filled out by the player.

27. The method of claim 25, wherein the points accounting module comprises a computer-software-based table created to be operated by the player utilizing a personal computing system.

28. The method of claim 27, wherein the personal computing system is selected from the group consisting of: a smartphone, a personal computer, a tablet computer, and an electronic gaming console.

29. The method of claim 18, wherein the operating points budget may be varied between sequential turns.

30. The method of claim 29, wherein the operating points budget may be varied by user activation of a chance-based points selector configured to return a points value from a predetermined superset of values.

31. The method of claim 30, wherein the chance-based points selector is selected from the group consisting of: a spinner; a die; and an electronic random number generator.

32. The method of claim 20, wherein one player's gamepiece may be defeated if the life points associated with such gamepiece are less than or equal to the cumulative attack points utilized against it by another player.

33. The method of claim 32, wherein a player is deemed to have lost a game when a base gamepiece of such player has been defeated.

34. The method of claim 24, wherein the gameboard is configured to define rows and columns of spaces, wherein one or more of the spaces of a second row of the gameboard are permanently designated for the specific operational purpose of comprising a base location, and wherein one or more other spaces of first row of the gameboard are permanently designated for the specific operational purpose of comprising a recruitment location.
